(19) United States
(12) Patent Application Publication
(10) Pub. No.: US 2007/0226681 A1
(43) Pub. Date: Sep. 27, 2007

(54) System for annotation based model driven software development

(75) Inventor: Lars Thorup, Birkerod (DK)

Correspondence Address: OLIFF & BERRIDGE, PLC, P.O. BOX 19928, ALEXANDRIA, VA, 22320, US

(73) Assignee: BESTBRAINS ApS, COPENHAGEN K (DK)

(21) Appl. No.: 11/386,665

(22) Filed: Mar. 23, 2006

(51) Int. Cl. G06F 9/44

(52) U.S. Cl. 717/104

(57) ABSTRACT

The invention relates to a system for annotation based model driven software development comprising a source code and a model. The system further comprises an element in said model linked to at least one element in said source code through an annotation. Hereby is achieved to maintain and develop software systems through a model driven development environment and to maintain correspondence between source code and model (including possibility for round-tripping) with a reduced amount of complexity and development effort. Further, it is achieved to have one system/modelling tool able to comprise an entire software system. Further, it is achieved to allow the user to make changes to both the model and the source code.

### FIELD OF INVENTION

The invention relates generally to a system for model driven software development comprising a source code and a model.

### BACKGROUND OF THE INVENTION

A big problem area within software development today and in the foreseeable future is the size and the complexity of the software systems. Most enterprise software systems are so big that no single person can grasp the entire system comprising millions of lines of source code divided into thousands of individual source code files and using different programming languages for different parts of the software layers. A larger and larger part of the development effort is therefore used to handle this complexity through communication and coordination. This slows down the development of big software systems and thus raises their cost.

A way to tackle the complexity in developing and/or maintaining big software systems is to use model-driven development of software. In an ideal model driven development and/or maintenance project of a software system, the project team will develop and/or maintain a high-level model of the software system and use an automated tool to maintain a complete correspondence between the model and the different kinds of source code of the system itself. A consequence of the model being high-level is that a lot of details are excluded, meaning that the model is much smaller than the source code and therefore much easier to grasp and/or manipulate for the software developers and other people working with them, such as documenters, project managers and testers. Changes to the software can therefore be made a lot faster and, by way of the modelling tool, be forwarded to the actual source code automatically.

Unified Modeling Language tools (UML tools, e.g. Rational XDE from IBM and the class designer in Visual Studio from Microsoft) are prior art modelling tools. UML tools focus on only one part of the entire software system, namely the domain objects, also called the business logic layer. The part of the model describing the domain objects is called the domain model, and the UML tool connects the domain model with the source code defining those domain objects. Often UML tools possess full round-trip capabilities meaning that changes can be made both in the model and in the source code and the tool ensures that changes are propagated to maintain complete correspondence between model and source code. However, to have a model for the entire system would require connecting the domain model with other parts of the model (such as a database model and a user interface model) and UML tools does not handle this connection very well if at all. This means that a large part of the modelling of the complete software system remains a manual activity without any tool support and therefore no saving in development effort is gained for this part. In addition the complexity of the modelling activity is further increased by having to do modelling in two different ways. This added complexity subtracts from the potential savings in development effort.

Likewise, application generators are prior art modelling tools. Examples of application generators are e.g. DeKlarit from DeKlarit and BlueInk from BlueInk. Application generators focus on the complete generation of an entire software system from an application model. However, application generators lack round-trip capabilities as developers can only make changes to the model not to the generated source code. In practice developers often need to change some details in selected places that cannot be described explicitly in the model. This could be special user interface requirements or integrations to non standard data sources. Often application generators make special hooks available for making some of those changes, but often developers need to make changes that are not supported by the tool. An example of a special user interface requirement could be the colouring of special field values to attract the user's attention. An example of an integration could be the lookup of some piece of information in an unusual data source, like a public web service. To handle these special cases, developers will need to use a lot of extra effort circumventing the application generator in clever ways or completely stop generating code for those parts of the model and start maintaining the correspondence between the model and source code for these parts manually. Both these kinds of activities add to the complexity of the development meaning that a bigger development effort is required.

U.S. Pat. No. 6,874,140 describes a computerized method and a computer-readable medium for annotation of a source code and the executable code generated from the source code. The annotation in the executable code is not executed but remains in the executable code for use during e.g. debugging of the source code thereby yielding additional information to the software developers regarding the position of e.g. an error in the source code during debugging. The abovementioned patent thereby eliminates the need of parallel signal command files, compilation of special versions of the executable program and the need for implementing debug statements in the source code. However, U.S. Pat. No. 6,874,140 does not describe a modelling tool for maintaining a correspondence between a model and a source code. Further U.S. Pat. No. 6,874,140 does not describe the development of a software system in an model-driven environment.

An object of an embodiment of the present invention is to maintain and develop software systems through a model driven development environment and to maintain correspondence between source code and model (including possibility for round-tripping) with a reduced amount of complexity and development effort. More specifically, an object is to have one system/modelling tool able to comprise an entire software system. Further, an object is to allow the user to make changes to both the model and the source code.

### SUMMARY OF THE INVENTION

The present invention solves among other things the abovementioned problems by:

A system comprising a modelling tool for model driven software development comprising a source code and a model

WHEREIN

an element in said model is linked to at least one element in said source code through an annotation.

The system comprising a modelling tool provides for linking an element in a model to at least one element in a source code by annotation. Thereby round-tripping between model and source code is possible due to a constant correspondence between source code and model made possible by the annotations in the source code. Further, complexity and development effort is reduced since only the programming language of the source code is required for the user to know, no special hooks are needed, etc. Further, the system is able to maintain and develop an entire software system since the system is able to address all aspects and all parts of a software system. Further, the system allows for changes in both model and source code since the system is able to manipulate both the source code elements and the model elements.

In one embodiment, said annotation is part of the source code.

In this way both relative and absolute annotation is possible. Having the annotation in the source code allows for both relative and absolute annotation. Having the annotation outside the source code allows for absolute annotation but allows for having annotations in e.g. one or more separate files thereby facilitating the locating and interpretation of the annotations.

In one embodiment, said annotation is situated in at least one of the following places in the source code selected from the group of:
before a source code element, and
after a source code element.
   In this way, by having the annotation either before or after a source code element referred to by said annotation, it is easy for the system and for a user to find and read annotations in the source code. By having an annotation in a source code element may make it easier to distinguish which source code element the respective annotation is linking.

In one embodiment, said annotation comprises at least one of the following:
a source code anchor referencing a source code element linked by said annotation,
a model anchor referencing a model element linked by said annotation, and
a link operator defining a relation between a source code element and a model element linked by said annotation.
   In this way the effect of a link is easily determined by examining the associated annotation. A source code anchor, a model anchor and a link operator or any combination of the three will determine the affect of an annotation and thereby the link between a source code element and a model element. By source code anchor is meant an identification of a source code element, by model anchor is meant an identification of a model element, and by link operator is meant a type of relationship between the source code element and the model element in a link defined by the annotation.

In one embodiment, said modelling tool provides access to said source code for a plurality of users.

In this way a plurality of users may access the source code using a copy of the modelling tool. Thereby a plurality of persons may share access to the source code.

In one embodiment, said annotation is abbreviated according to a definition in a library of abbreviations. In this way a source code comprising annotations will be easier to read for a user and it will facilitate the writing of annotation in a source code by a user.

In one embodiment, said library of abbreviations is included in at least one of the following:
said system, and
said source code.
   In this way the library of abbreviations may be separated from the source code by placing the library in the system or it may be a part of the source code. This may facilitate the locating of the library of abbreviations, both for the system and for a user.

In one embodiment, said annotation is part of the model. In this way the annotations may be part of the model instead of being part of the source code. This may facilitate the target software development since the main features of the system are situated in the model.

In one embodiment, said annotation is defined in said source code by a marker, said marker being a comment marker of the programming language used.

In this way a dual effect is obtained: First, the annotation marker tells the system comprising a modelling tool that this is an annotation to be processed by the tool. Second, by starting with the comment symbol of the programming language, the annotation marker tells the compiler/translator to ignore the annotation during compilation/translation.

In one embodiment, said system comprises a processor for generating a model from said source code by processing annotations in said source code.

In this way a model may be generated from a source code by processing annotations in the source code.

In one embodiment, said system comprises a processor for processing a change in a model element by changing a source code element linked to said model element by an annotation.

In this way changes to a model are propagated to the source code by changing the source code elements referenced by annotations affected by said model changes.

In one embodiment, said system comprises a processor for processing a change in a source code element by changing a model element linked to said source code element by an annotation.

In this way changes to a source code are propagated to the model by changing the model elements referenced by annotations affected by said source code changes.

In one embodiment, said annotation comprises a marker, a source code anchor, a link operator and a model anchor. In this way the form of an annotation may be a marker (e.g. //#), a source code anchor (e.g. /Next/Class/Name), a link operator (e.g. in), and a model anchor (e.g. EntityCollection).

Embodiments of the present invention also relates to a method corresponding to embodiments of the system comprising a modelling tool according to the present invention.

More specifically, the invention relates to a method for model driven software development comprising a source code and a model in which the method comprises linking an element in said model to at least one element in said source code by annotation.

The method and embodiments thereof correspond to the system comprising a modelling tool and embodiments thereof and have the same advantages for the same reasons.

Advantageous embodiments of the method are defined in the sub-claims and described in detail in the following.

Further, the invention also relates to a computer program comprising program code adapted to cause a data processing system to perform the steps of the method according to claim 14 when said program code is executed by said data processing system.

Further, the invention relates to a computer readable medium having stored thereon a computer program comprising program code adapted to cause a data processing system to perform the steps of the method according to claim 14 when said program code is executed by said data processing system.

### BRIEF DESCRIPTION OF THE DRAWINGS

FIG. 1 represents a schematic drawing of a device according to an embodiment of the present invention.

FIG. 2 represents a schematic drawing of an embodiment of the invention illustrating an exemplary system for model driven software development.

FIG. 3 represents a schematic drawing of an annotation linking one model element to two source code elements according to an embodiment of the present invention.

FIG. 4 represents a schematic drawing of a system according to an embodiment of the present invention comprising a model and a source code and annotations situated before the source code elements linked by the annotations.

FIG. 5 represents a schematic drawing of a system according to an embodiment of the present invention comprising a model and a source code and annotations situated after the source code elements linked by the annotations.

FIG. 6 represent a schematic drawing of an annotation situated in the source code element that is linked by the annotation according to an embodiment of the present invention.

FIG. 7 represents a schematic drawing of an annotation of a model comprising a link between a model element and a source code element according to an embodiment of the present invention.

FIG. 8 represents a schematic drawing of several annotations linking several source code elements to several model elements according to an embodiment of the present invention are presented.

FIG. 9 presents a flowchart of a modelling tool using annotations in a source code to maintain consistency between a model and said source code according to an embodiment of the present invention.

FIG. 10 represents a schematic drawing of abbreviations and abbreviation definitions according to an embodiment of the present invention.

### DETAILED DESCRIPTION OF THE INVENTION

In the following detailed description of exemplary embodiments of the invention, reference is made to the accompanying drawings which form a part hereof, and in which is shown by way of illustration specific exemplary embodiments in which the present invention may be practiced. These embodiments are described in sufficient detail to enable persons skilled in the art to practise the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

In the following detailed description the below-mentioned definitions are used:

Target Software: Software that programmers create in any programming language for any purpose e.g. software executable by a computer or other logical circuitry.

Source code: The representation of the target software that may be manipulated by programmers.

Modelling tool: Software that is an embodiment of the present invention. Programmers may use the modelling tool to manipulate the source code of the target software.

Model: A representation of the target software created by the modelling tool.

Source code element: An identifiable part of the source code (e.g. class Product, table customer or any other identifiable part of the source code). Source code elements may contain other source code elements.

Model element: An identifiable part of the model. Model elements may contain other model elements.

Source code anchor: An identification of a source code element.

Model anchor: An identification of a model element.

Link: A reference between a source code element and a model element.

Link operator: Denotes the type of relationship between the source code element and the model element in a link.

Annotation: The representation of a link consisting of a source code anchor and model anchor and a possible link operator.

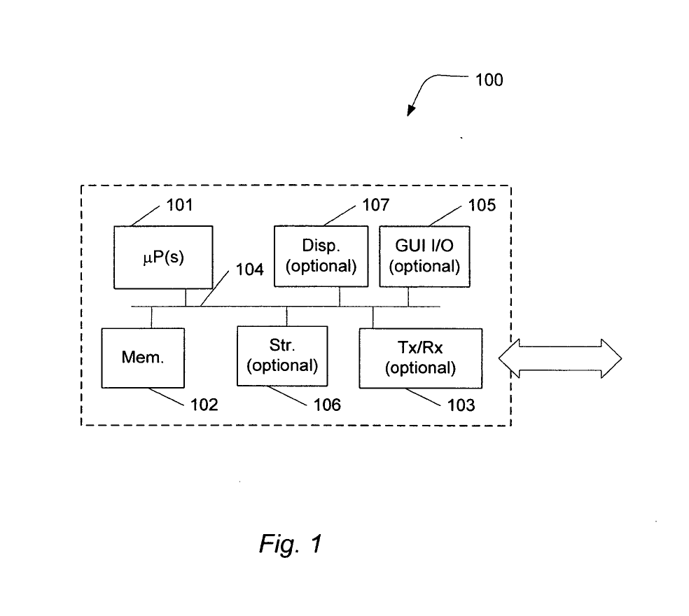

In FIG. 1 a schematic drawing of a device according to an embodiment of the present invention is presented. Shown is a device (100) according to an embodiment of the present invention. The device (100) comprising one or more micro-processors (101) connected with a main memory (102) and e.g. one storage device (106) via an internal data/address bus (104) or the like. Additionally, the device (100) may also be connected to or comprise a display (107) and/or communication means (103) for communication with one or more remote systems via a network. The memory (102) and/or storage device (106) are used to store and retrieve the relevant data together with executable computer code for providing the functionality according to the invention. The micro-processor(s) (101) is responsible for generating, handling, processing, calculating, etc. the relevant parameters and data according to the present invention.

The storage device (106), which may be optional, comprises one or more storage devices capable of reading and possibly writing blocks of data, e.g. a USB-slot for memory cards, DVD, CD, optical disc, PVR, etc. player/recorder and/or a hard disk (IDE, ATA, etc), floppy disk, smart card, PCMCIA card, magnetic tape, etc.

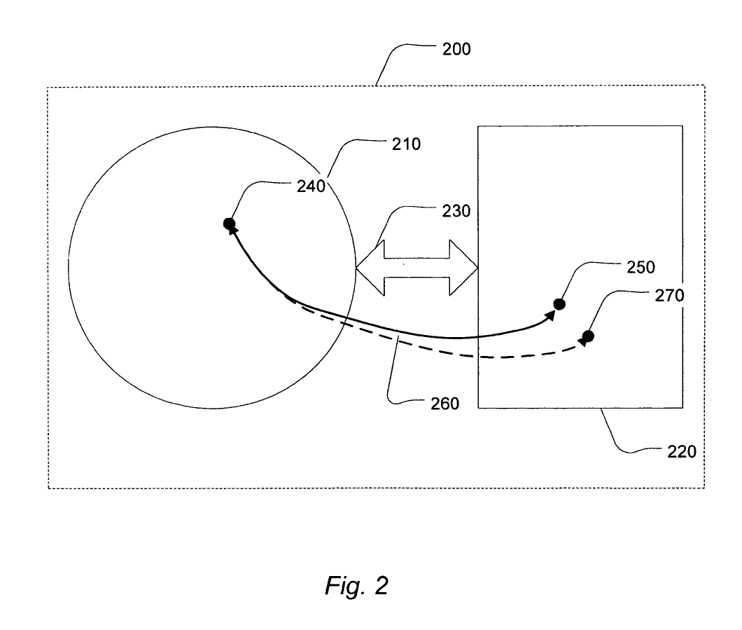

In FIG. 2 a schematic drawing of an embodiment of the invention illustrating an exemplary system for model driven software development (200) is presented. The system (200) comprises a model (210), and a source code (220).

The source code (220) may be a file comprising a series of statements written in some human-readable computer language such as C, C++, C#, assembler, Fortran, BASIC, Pascal, Java, LISP, ML, Objective-C, Perl, PHP, Python, Matlab, Visual Basic, SQL, HTML, XML, or any other form of computer language. Alternatively, the source code may comprise graphical information defining some human-readable computer language represented by graphical elements.

The file comprising the source code may be stored on a storage device (not shown; see e.g. (106) in FIG. 1) and/or in a memory (not shown; see e.g. (102) in FIG. 1). The source code may be printed on paper. The source code may be represented on a display (not shown; see e.g. (107) in FIG. 1). The source code may comprise one or more files.

The model (210) is an abstraction from the source code and will therefore typically comprise less detail than contained in the source code. The model may be a graphical model of any type, e.g. a tree structure, a relational chart, etc. Alternatively, the model may be a textual model.

The model may be represented on a display (not shown; see e.g. (107) in FIG. 1) or on paper. Alternatively, the model may be stored on a storage device (not shown; see e.g. (106) in FIG. 1) and/or in a memory (not shown; see e.g. (102) in FIG. 1).

The relation between the source code and the model is represented by the double-arrow (230) indicating that round-tripping is possible i.e. it is possible to go from the model and generate the source code and/or to go from the source code and generate the model. It is possible to go from the source code to the model and/or vice versa one or more times iteratively throughout the development and maintenance process.

The relation (230) is manifested by links between the source code and the model. A link (260) connects a source code element (250) to a model element (240). A model element may be linked to one or more source code elements (250 and 270). A source code element is not required to be linked to a model element i.e. a source code element is linkable to a model element meaning that a source code element may be linked to zero, one or more model elements.

A source code element may be any part of a program e.g. a class, a table, a function, a display object, a type, a variable, a constant, a string, an object, an expression, a statement block, etc. or any other part of the source code.

A model element may be any graphical object representing a source code element, e.g. a square, a circle, a cube, a sphere or any other graphical object. Alternatively a model element may be a character or a character string. Alternatively a model element may be any combination of graphical objects and characters and/or character strings.

Alternatively, (230) may represent a modelling tool for generating a model from an annotated source code. Alternatively, (230) may represent a modelling tool for generating an annotated source code from a model. Alternatively, (230) may represent a modelling tool capable of generating a model from an annotated source code and/or generating an annotated source code from a model.

Alternatively, (230) may represent a modelling tool capable of propagating changes in the model to corresponding changes in the source code and/or propagating changes in the source code to corresponding changes in the model.

A link refers directly to a source code element. Thus the modelling tool may manipulate source code elements referred by links without affecting source code elements not referred by links. Thus a software developer maintains the full capability of manipulating the source code manually or by other means.

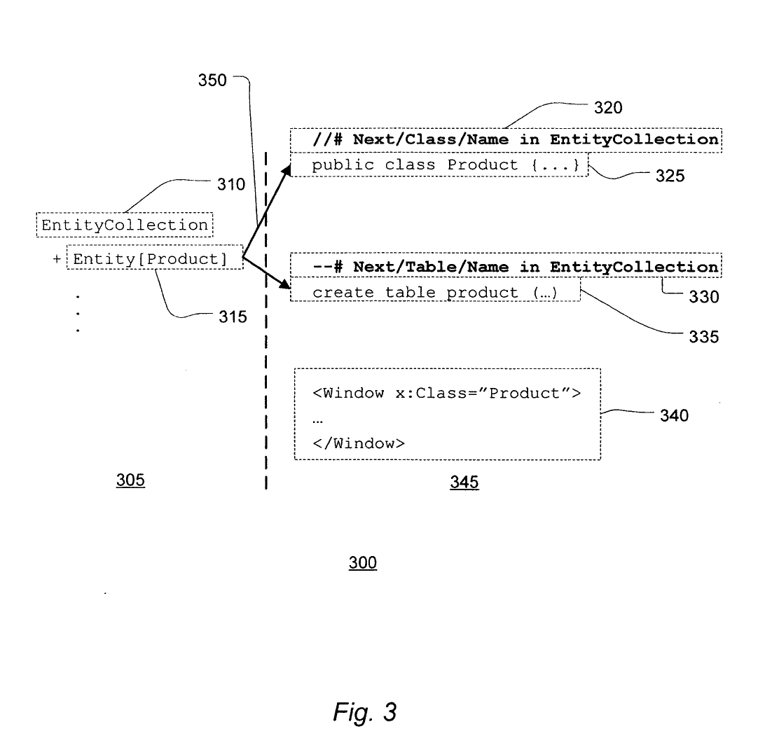

This is exemplified in FIG. 3, where a schematic drawing of a system according to an embodiment of the present invention is presented. A system for model driven software development (300) comprising a model (305) and a source code (345) is presented. A link (350), defined by the annotations (320) and (330), refers directly to the source code elements (325) and (335), but not to the source code element (340). Thus, a change in the model element (315) would yield a change in source code elements (325) and (335) but not to (340). Thereby, the source code may be the primary medium expressing the workings of a software system so a software developer maintains access to the full expressiveness of the programming language of the source code.

In this example the business logic layer (320;325) is programmed in C#, the database (table) (330;335) is programmed in SQL and the user interface (window) (340) is programmed in XAML. Alternatively any other programming language or group of programming languages may be used for the source code or parts of it. Alternatively, a single programming language may be used for the entire source code.

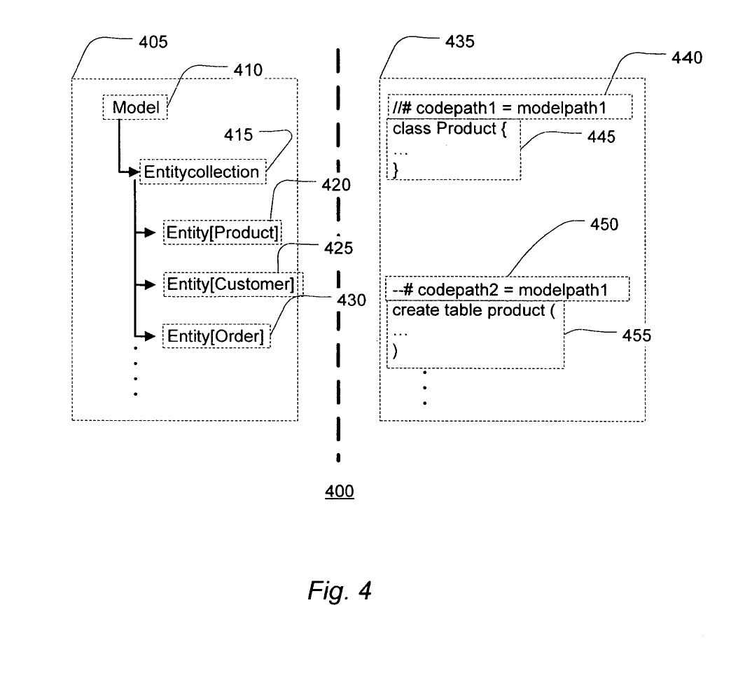

In FIG. 4 a schematic drawing of a system according to an embodiment of the present invention is presented.

Shown is a system for model driven software development (400) according to another embodiment of the present invention. The system comprises a model (405). The model comprises a model element “Model” (410) indicating that this is the model part of the system. The model further comprises a model element “Entitycollection” (415). The Entitycollection comprises three model elements: “Entity[Product]” (420), “Entity[Customer]” (425) and “Entity[Order]” (430).

The system further comprises a source code (435) comprising the source code element “class product” (445), and the source code element “table product” (455).

Further, the source code comprises an annotation (440) linking the source code element “class product” (445) to the model element “Entity[Product]” (420). Further, the source code comprise an annotation (450) linking the source code element “table product” (455) to the model element “Entity[Product]” (420). The source code may comprise one or more annotations. In this example the model element “Entity[Product]” therefore links to both a class and a table in the source code.

Likewise there may be annotations linking other model elements (e.g. Customer (425) and/or Order (430)) with source code elements (either (445) or (455), or other elements not illustrated in the figure).

As seen in FIG. 4, an annotation (440, 450) linking a source code element (445, 455) to a model element (420) may be situated before the source code element (445, 455) as illustrated by the annotations (440 and 450).

In this example two programming languages have been used, C# for the business logic layer (440;445) and SQL for the database (450;455). Alternatively any other programming language or group of programming languages may be used for the source code or parts of it. Alternatively, a single programming language may be used for the entire source code.

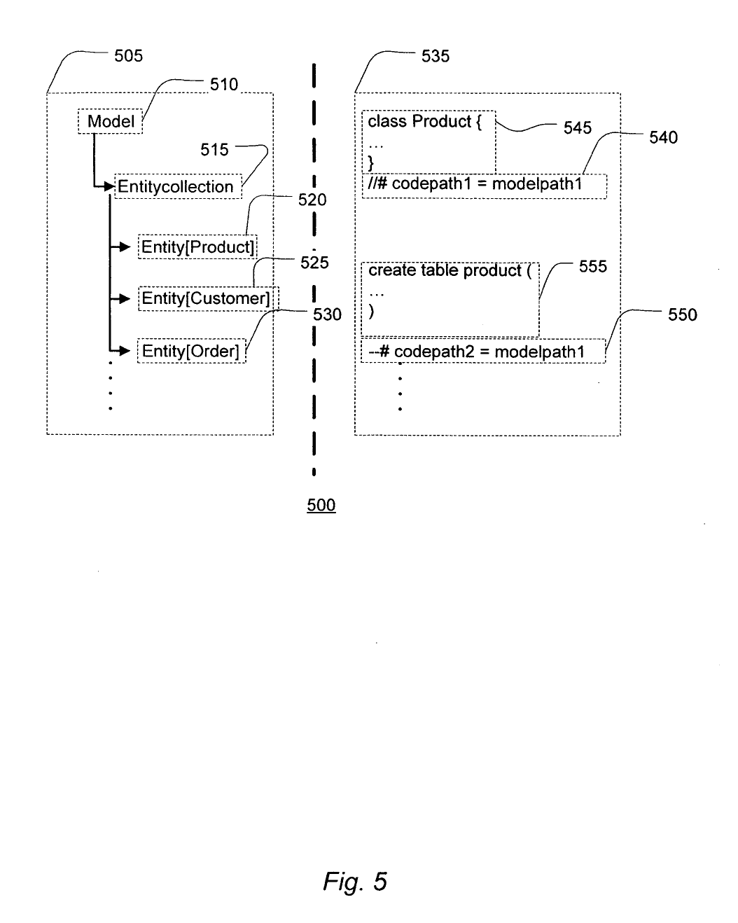

Alternatively, an annotation (540, 550) linking a source code element (545, 555) and a model element (520) may be situated after the source code element (545, 555) as illustrated by the annotations (540) and (550) in FIG. 5. FIG. 5 shows the same as FIG. 4 except that the annotations are situated after the source code elements.

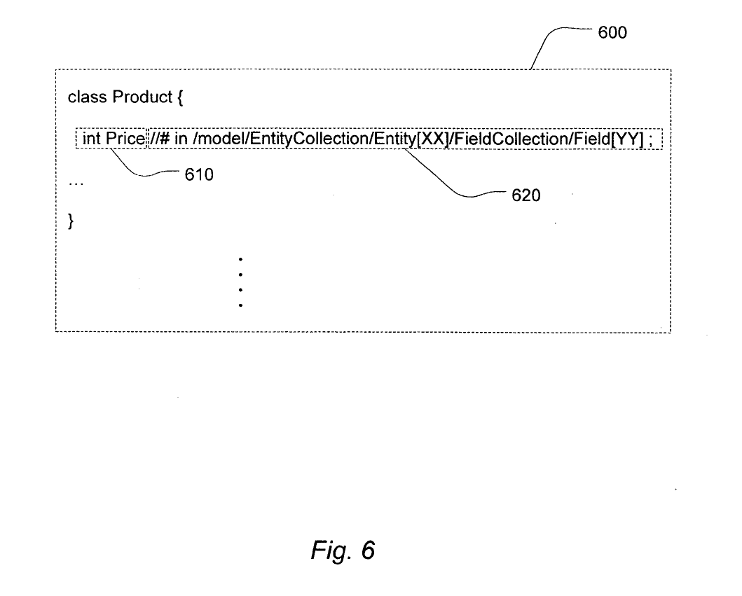

Alternatively, an annotation linking a source code element and a model element may be situated in the source code element that the annotation is linking as illustrated in FIG. 6. In (600) a piece of source code is presented in which the annotation (620) is placed right after the source code element (610) in the source code (600) that is linked by the annotation. In the example, XX and YY may depend on whether relative or absolute annotation is used (see below for a detailed explanation of relative and absolute annotation). In the case of relative annotation XX and YY may comprise the word Current and in the case of absolute annotation XX may be Product and YY may be Price. In this example the annotation comprises a link operator (“in”) and a model anchor (“/model/EntityCollection/Entity[XX]/FieldCollection/Field[YY]”) but not a code anchor which is not needed as the position of the annotation yields the code element to be linked (in this case “Price”).

Alternatively, an annotation linking a source code element to a model element may be situated anywhere in the source code or in other files.

Alternatively, an annotation linking a source code element to a model element may be situated in a separate file or in separate files. If an annotation is placed in a separate file only absolute annotation (as described below) is possible.

Alternatively, an annotation linking a source code element to a model element may be situated in the source code and comprise a textual part and a graphical part. E.g. the textual part may comprise the source code anchor and the graphical part may comprise the model anchor or vice versa.

In the example of FIG. 6, a single programming language (C#) has been used for the entire source code. Alternatively any other programming language or group of programming languages may be used for the source code or parts of it.

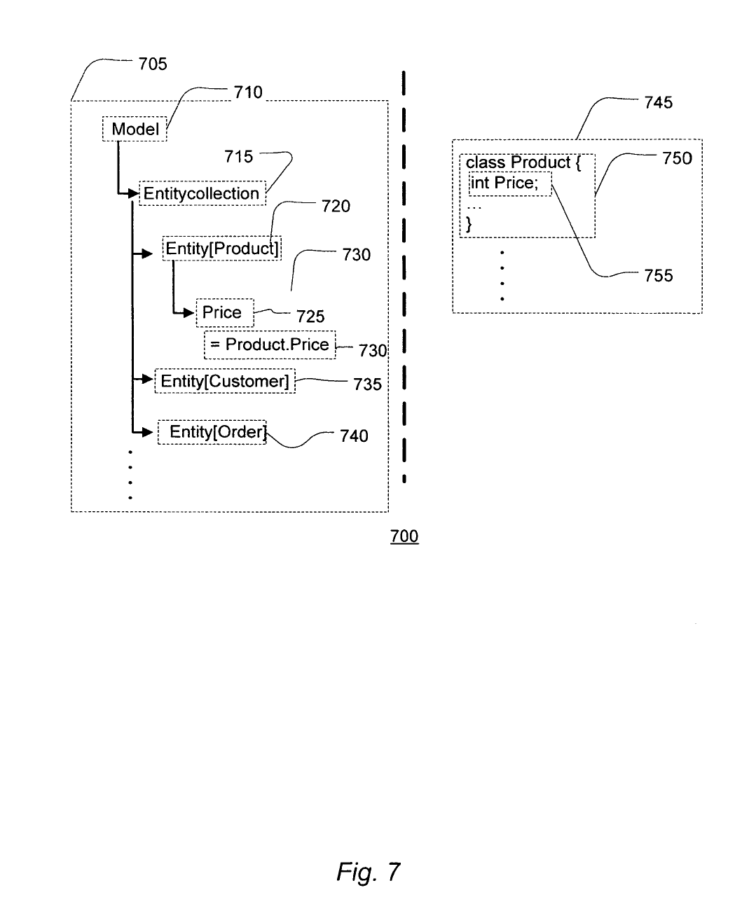

Alternatively, the annotation may be situated in the model as exemplified in FIG. 7. This embodiment of the present invention comprises a model (705) and a source code (745) and an annotation (730) situated in the model. The form of the annotation in the model may be to have e.g. a “=” or any other form of sign or sequence of signs or graphical element, extending from the model element (725) in the model to e.g. a source code anchor in the annotation (730). In this example is used an annotation comprising “=product.price” (730), thus the annotation comprises a link operator and a source code anchor. “product.price” indicates the class in the source code in which the source code element is to be found, product (750), and the name of the source code element, price (755), to which the model element (725) is linked with. The product.price thus represents the source code anchor. In the example the link operator is “=”, expressing that the source code element identified by the source code anchor is defined to be identical to the preceding model element, Price. Thus, a link between the source code element and the model element is made. No model anchor is needed in this example since the annotation refers directly back to the previous model element, Price. The annotation used in this example is absolute annotation as defined below.

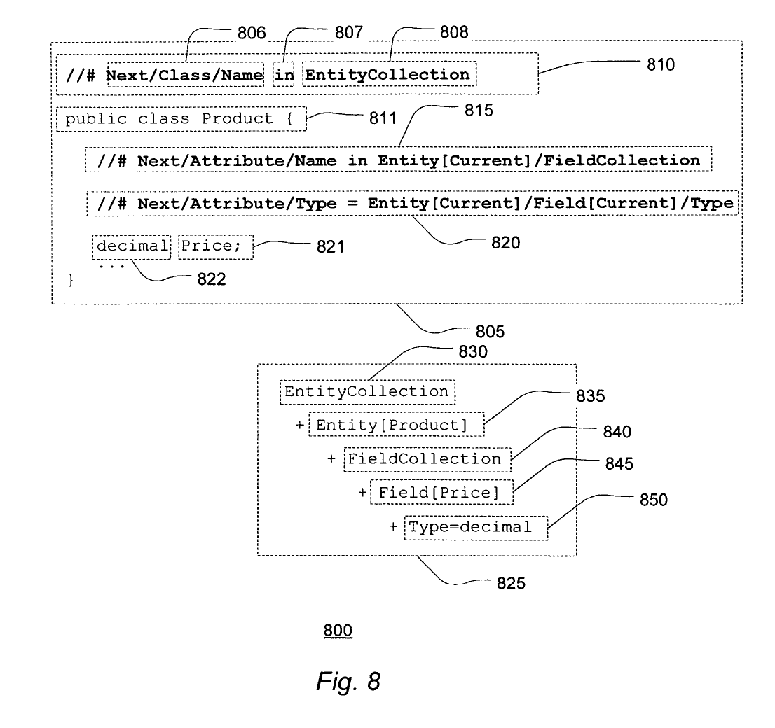

In FIG. 8 a schematic drawing of annotations according to an embodiment of the present invention are presented. Shown are annotations linking several source code elements to several model elements according to an embodiment of the present invention. In the example, the source code is expressed in a C-type language and the model is represented by a tree structure, but the present invention applies to any programming language and any type of model representation.

The example represents a target software system for a retail store selling some products, but the present invention applies to any target software system. In the model for this example references are made to some entities, e.g. Product, Customer and Order. In the model (825) each entity contains a set of fields holding information about the entity, e.g. Description, Price (821), Name and Date.

In the figure, a source code (805) and a model (825) are represented. The source code comprise an annotation (810) written as “//# Next/Class/Name in EntityCollection” defining a source code anchor “Next/Class/Name” (806) to the name of the next class, “product” (811), in the source code. The annotation also comprise a model anchor, “EntityCollection”, (808) to an element in the model, “EntityCollection” (830). Further, the annotation comprise a link operator, “in” (807), expressing that the model element corresponding to the source code element “product” is included in the model element “EntityCollection”. The effect of the inclusion is illustrated by the model element “Entity[Product]” (835) which is situated in the “EntityCollection” element (830) of the model (825).

The annotation (815) in FIG. 8, written as “//# Next/Attribute/name in Entity[Current]/FieldCollection”, expresses that the name of the next occurring attribute, “Price” (821), in the source code is included in the “Fieldcollection” (840) of the current entity (currently the product entity (835)) of the model as illustrated by (845). Here, the source code anchor is written as “Next/Attribute/name”, thus defining a source code element (821). The model anchor is written as “Entity[Current]/FieldCollection”, thus defining a model element (840) linked to the source code element (821). As above the link operator is the “in” link operator.

The annotation (820) in FIG. 8, written as “//# Next/attribute/Type=Entity[Current]/Field[Current]/Type”, expresses that the type “decimal” (822) of the next occurring attribute, “Price” (821), in the source code is included in the current field “Price” (845) of the current entity “product” (835) as a type, as illustrated by (850). In this example the link operator is “=” expressing that the source code anchor (“Next/attribute/Type”) is defined to be identical to the model anchor (“Entity[Current]/Field[Current]/Type”) yielding that the type (822) “decimal” of the source code element “Price” (821) is identical to the type (850) of the model element “Price” (845).

Another example of a link operator is the “LowerCase” link operator. This operator is used in the syntax: source code anchor LowerCase model anchor and takes the characters of the model element referred to by the model anchor and converts the characters of this element to small characters. These small characters are then placed in the source code element referred to by the source code anchor. This link operator is valuable when more than one type of programming language is used in generating the target software e.g. SQL for database programming, C# for business logic programming and XAML for user interface programming. These three programming languages require different syntaxes of variable names and thus a good starting point for fulfilling this requirement is to have the variable name in lower case characters for further processing.

Note that in the example the symbol “//#” is used as an annotation marker with a dual effect: First, the annotation marker tells the modelling tool that this is an annotation to be processed by the tool. Second, by starting with the comment symbol of the programming language, the annotation marker tells the compiler/translator to ignore the annotation during compilation/translation. As the present invention applies to any programming language the actual choice of annotation marker will depend on the comment convention of the programming language. Thus the present invention applies to any choice of annotation marker having the dual effect. Alternatively, the present invention applies to any choice of annotation marker.

According to an embodiment of the present invention only the source code and/or model are manipulated by the modelling tool. The modelling tool does not manipulate the executable target software. Therefore, the modelling tool has no implications on the executable target software generated from the source code via a translator/compiler.

In FIG. 8 the annotations are given as relative values to the “Current” position in the source code and model. Alternatively, annotations may be given as absolute values. In this example a relative annotation as (815) //# Next/Attribute/Name in Entity[Current]/FieldCollection would in an absolute version be written as //# Class Product/Attribute Price/Name in Entity[Product]/FieldCollection. Alternatively, any combination of relative and absolute annotations may be used.

Alternatively, an annotation may comprise any number of relative and/or absolute model anchors and source code anchors.

Annotations may be written in any part of a source code for a target software system and thus the modelling tool can ensure that the source code for the entire target software system is kept consistent with the model.

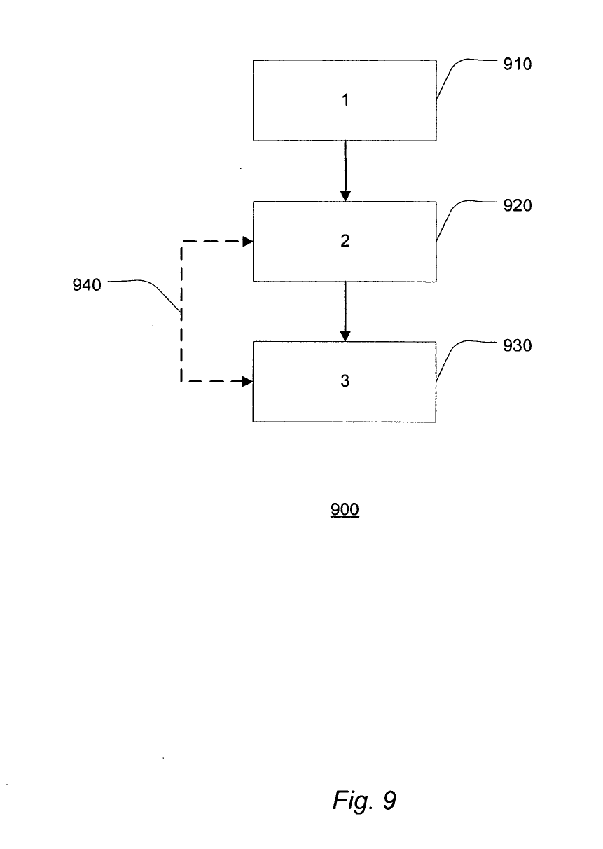

FIG. 9 presents a flowchart (900) of how the modelling tool by use of annotations in a source code may maintain consistency between a model and a source code according to an embodiment of the present invention.

The modelling tool may use annotations in the source code to maintain consistency between the model and the source code in the following ways:
1. When the modelling tool for the first time reads the source code (910), it will create the model by processing each and every annotation found in the source code. This processing amounts to filling the model element identified by the model anchor with a transformation of the text from the source code element identified by the source code anchor. The transformation applied is specified by the link operator of the annotation. This processing can be seen as a special case of the processing step described in item 3 (930).
2. When a software developer manipulates the model (920), the modelling tool will find and process all the annotations that refer to the changed model elements. This processing amounts to replacing the text from the source code element identified by the annotation with a transformation of the model element identified by the same annotation. The transformation applied is specified by the link operator of the annotation.
3. When a software developer manipulates the source code (930), the modelling tool will find and process all the annotations that refer to the changed source code elements. This processing amount to filling the model element identified by the annotation with a transformation of the text from the source code element identified by the same annotation rule. The transformation applied is specified by the link operator of the annotation.

Alternatively, the steps of (920) and (930) may be repeated one or more times in any order as indicated by (940).

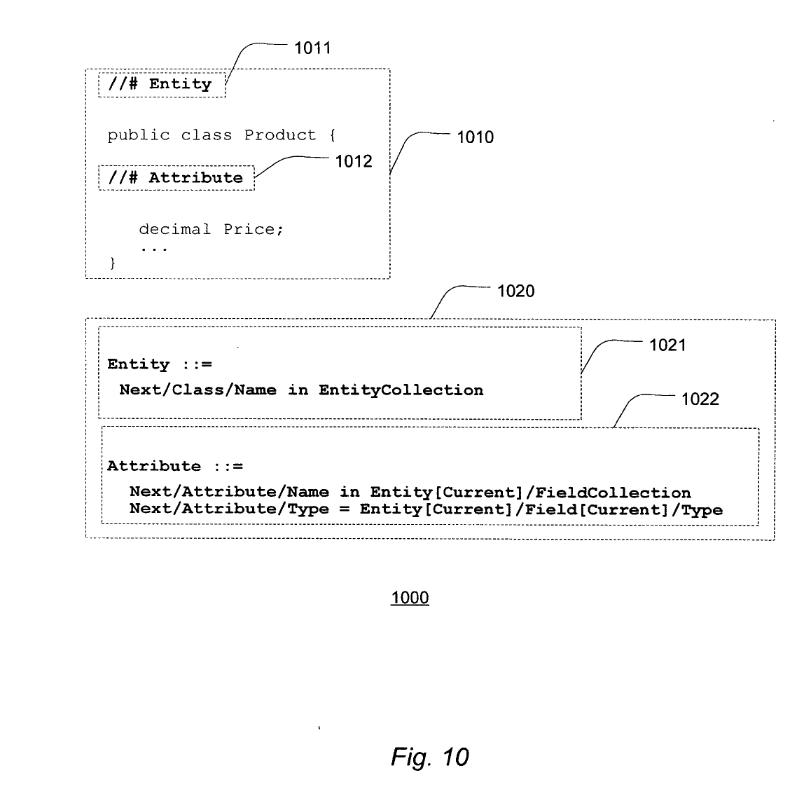

In FIG. 10 a schematic drawing of abbreviations and abbreviation definitions (1000) according to an embodiment of the present invention are presented. In FIG. 10, (1010) represents the same piece of source code as in FIG. 8 (805) but in (1010) abbreviations of the annotations have been used instead of the annotations used in (805). (1011) represent the abbreviation of the annotation (810) in FIG. 8, and (1012) represents the abbreviation of the annotations (815) and (820) in FIG. 8. The abbreviations may be defined in a library of abbreviations that may be included in the modelling tool or in the source code or in one or more separate files. The library of abbreviations comprises a definition of the abbreviations as illustrated in (1020) of FIG. 10. In FIG. 10, (1021) represents the definition of the abbreviation (1011) and likewise (1022) represents the definition of the abbreviation (1012).

Alternatively, only abbreviations for the most frequently used (e.g. used more than three times in a source code) annotations are created in the abbreviation library.

In this example a C-type language has been used for programming language, however the present invention applies to any choice of programming language.

In general, an abbreviation may be expanded to the annotation that the abbreviation has been defined to denote before e.g. the processing as illustrated in FIG. 9 takes place.

If one or more users (persons, software developers, etc.) have access to the same source code they will be presented for the same model since the source code represents the model through the annotations and identical versions of a source code yield identical annotations and thereby identical models. As an example, if a development team comprises software developers in e.g. different continents working at a software system offset in time, then the changes made by developers in a first continent to the model will be saved in the corresponding source code by the modelling tool. As the developers in a second continent at a later time loads the latest version of the source code into the modelling tool, the modelling tool will automatically generate the same model as the model worked on by the developers in the first continent whereby consistency is maintained between the model and the source code.

A problem faced by model driven development tools of today is the limited ability to version control the model. Existing model driven development tools maintain a separate representation of the model that software developers typically manipulate graphically while the version control system compares textual representations of the same model. However simultaneous changes of the model by different developers might lead to conflicts being reported from the version control system. The tool must then translate such conflicts from the textual representation and must essentially provide version control-like functions for letting developers solve model conflicts using the graphical interface. This problem is not solved by most existing tools.

In an embodiment of the present invention, the annotations are part of the source code with references to a model. Therefore, the version control problem is solved since version control software already available today may be used on the annotated source code. Thus it is not necessary to develop new types of version control software to be used with the present invention and thereby the advantages of present day version control software may be utilized.

One or more copies of a modelling tool may have access to the same source code thereby enabling one or more users to access the same model/source code.

1. A system comprising a modelling tool for model driven software development comprising a source code and a model
WHEREIN
an element in said model is linked to at least one element in said source code through an annotation.

2. A system according to claim 1
WHEREIN
said annotation is part of the source code.

3. A system according to claim 1
WHEREIN
said annotation is situated in at least one of the following places in the source code selected from the group of:
before a source code element and
after a source code element.

4. A system according to claim 1
WHEREIN
said annotation comprises at least one of the following:
a source code anchor referencing a source code element linked by said annotation,
a model anchor referencing a model element linked by said annotation, and
a link operator defining a relation between a source code element and a model element linked by said annotation.

5. A system according to claim 1
WHEREIN
said modelling tool provides access to said source code for a plurality of users.

6. A system according to claim 1
WHEREIN
said annotation is abbreviated according to a definition in a library of abbreviations.

7. A system according to claim 6
WHEREIN
said library of abbreviations is included in at least one of the following:
said modelling tool, and
said source code.

8. A system according to claim 1
WHEREIN
said annotation is part of the model.

9. A system according to claim 1
WHEREIN
said annotation is defined in said source code by a marker, said marker being a comment marker of the programming language used.

10. A system according to claim 1
WHEREIN
said system comprises a processor for generating a model from said source code by processing annotations in said source code.

11. A system according to claim 1
WHEREIN
said system comprises a processor for processing a change in a model element by changing an annotation linking said model element to a source code element.

12. A system according to claim 1
WHEREIN
said system comprises a processor for processing a change in a source code element by changing an annotation linking said source code element to a model element.

13. A system according to claim 1
WHEREIN
said annotation comprises a marker, a source code anchor, a link operator and a model anchor.

14. A method for model driven software development comprising a source code and a model
WHEREIN
the method comprises linking an element in said model to at least one element in said source code by annotation.

15. A method according to claim 14
WHEREIN
the method comprises storing said annotation in the source code.

16. A method according to claim 14
WHEREIN
the method comprises situating said annotation in at least one of the following places in the source code selected from the group of:
before a source code element, and
after a source code element.

17. A method according to claim 14
WHEREIN
said annotation comprises at least one of the following:
a source code anchor referencing a source code element linked by said annotation,
a model anchor referencing a model element linked by said annotation, and
a link operator defining a relation between a source code element and a model element linked by said annotation.

18. A method according to claim 14
WHEREIN
the method provides access to said source code for a plurality of users.

19. A method according to claim 14
WHEREIN
the method comprises abbreviating said annotation according to a definition in a library of abbreviations.

20. A method according to claim 19
WHEREIN
the method comprises including said library of abbreviations at least one of the following:
said modelling tool, and
said source code.

21. A method according to claim 14
WHEREIN
said annotation is part of the model.

22. A method according to claim 14
WHEREIN
the method comprises defining said annotation in said source code by a marker, said marker being a comment marker of the programming language used.

23. A method according to claim 14
WHEREIN
the method comprises a processor generating a model from said source code by processing annotations in said source code.

24. A method according to claim 14
WHEREIN
the method comprises a processor processing a change in a model element by changing an annotation linking said model element to a source code element.

25. A method according to claim 14
WHEREIN
the method comprises a processor processing a change in a source code element by changing an annotation linking said source code element to a model element.

26. A method according to claim 14
WHEREIN
said annotation comprises a marker, a source code anchor, a link operator and a model anchor.

27. A computer program comprising program code adapted to cause a data processing system to perform the steps of the method according to claim 14 when said program code is executed by said data processing system.

28. A computer readable medium having stored thereon a computer program comprising program code adapted to cause a data processing system to perform the steps of the method according to claim 14 when said program code is executed by said data processing system.
